(19) United States
(12) Patent Application Publication
(10) Pub. No.: US 2014/0040060 A1
(43) Pub. Date: Feb. 6, 2014

(54) SYSTEM OF PROVIDING EXPERT ANALYSIS TO CONSUMERS

(71) Applicant: Marc Lawrence Fredman, Chicago, IL (US)

(72) Inventor: Marc Lawrence Fredman, Chicago, IL (US)

(21) Appl. No.: 13/954,650

(22) Filed: Jul. 30, 2013

Related U.S. Application Data
(60) Provisional application No. 61/677,883, filed on Jul. 31, 2012.

(51) Int. Cl. G06Q 30/06

(52) U.S. Cl. CPC G06Q 30/0601
USPC 705/26.1

(57) ABSTRACT

A system of providing expert analysis of a product or service to a consumer, prior to the consumer buying the product or service. The product or service may include a used car being sold by a private seller. A consumer may request that the car be analyzed by an expert. The seller may receive the request and pick from a list of inspection locations to analyze the car. The seller may bring the car to the inspection location and the expert may analyze the car and upload the results to the consumer for review.

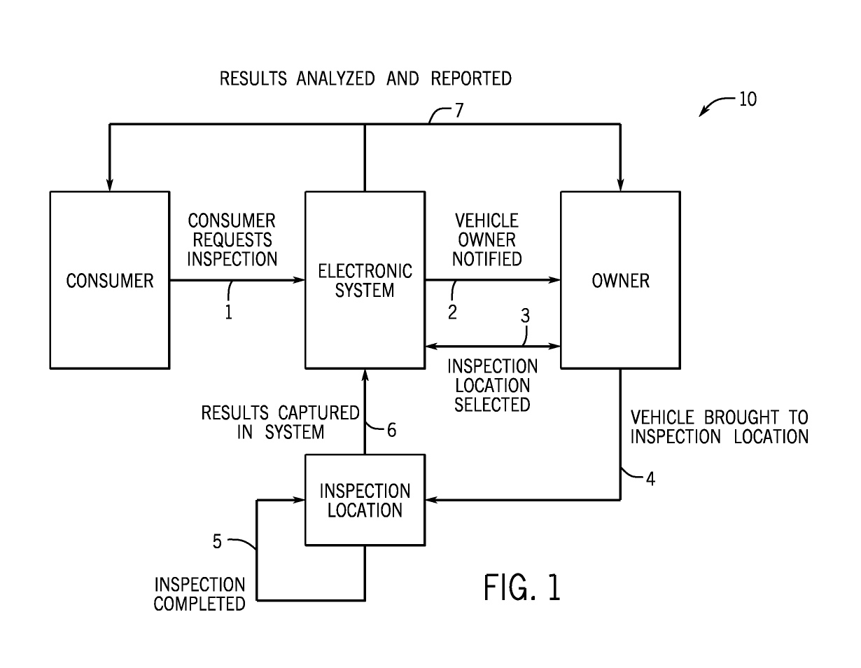

### CROSS-REFERENCE TO RELATED APPLICATION

This application claims the benefit of priority of U.S. provisional application No. 61/677,883, filed Jul. 31, 2012, the contents of which are herein incorporated by reference.

### BACKGROUND OF THE INVENTION

The present invention relates to a system of providing an expert analysis to consumers and, more particularly, to a system of providing an expert analysis of a used car to consumers.

Currently, people buy used vehicles directly from one another. However, the process may include a lot of risks for the purchaser. Unlike buying a new car with a warranty, or even a used car from a dealer, buying a car from an individual does not provide the same guarantees. Therefore, the buyer may purchase a vehicle with thousands of dollars of hidden damage. There are a few safety nets for prospective buyers, which may include reports such as Carfax®, or bringing the car to an auto repair shop before the purchase. However, reports only include information that has previously been inputted into the system and may have omissions that may have gone unreported. As for bringing the car to the auto repair shop, the process is informal and unstructured. The buyer and seller may have to select a mechanic, coordinate a time, and the results may be unclear to the purchaser.

As can be seen, there is a need for a safer and easier method of purchasing a used car from a private seller.

### SUMMARY OF THE INVENTION

In one aspect of the present invention, a system for a consumer to acquire an expert analysis of a product or service of a seller comprises: a computer having a user interface; and a program product comprising a machine-readable program code for causing, when executed, the computer to perform the following process steps: producing information to a consumer, wherein the information comprises a product or service to be sold by a seller; prompting a user to request an expert analysis about the product or service; receiving an input of the request for the expert analysis; notifying the seller of the request; prompting the seller to schedule an appointment with an expert for the expert analysis; receiving an input of the expert analysis; and producing the expert analysis to the consumer.

These and other features, aspects and advantages of the present invention will become better understood with reference to the following drawings, description and claims.

### BRIEF DESCRIPTION OF THE DRAWINGS

The FIGURE is a block diagram showing the steps of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system of providing expert analysis of a product or service to a consumer, prior to the consumer buying the product or service. The product or service may include a used car being sold by a private seller. A consumer may request that the car be analyzed by an expert. The seller may receive the request and pick from a list of inspection locations to analyze the car. The seller may bring the car to the inspection location and the expert may analyze the car and upload the results to the consumer for review.

The present invention may provide an efficient process for consumers to determine a used vehicle's current operating condition. The process of the present invention may eliminate inspection coordination issues by allowing the consumer to initiate a vehicle inspection and for the seller to then bring the vehicle to an inspection location that may be convenient for them. The present invention may provide an efficient and low-cost way to mitigate consumer risk while buying a used vehicle from an individual seller. The program of the present invention may create a structured and standardized method in which a consumer may initiate and then receive results for a used vehicle inspection. Further, the present invention may produce data and/or reports based on the results of the inspection.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. For example, the loaded software may include an application on a smart device. The software may be accessed by the computer using a web browser. The computer may access the software via the web browser using the internet, extranet, intranet, host server, internet cloud and the like.

As mentioned above, the present invention may include a software program, a computer that implements the software program, and a database that is accessed by the software program. Referring to the FIGURE, the present invention may further include multiple steps 10. The steps 10 may include a consumer requesting an inspection 1. The consumer may first find a vehicle in which the consumer is interested in purchasing. If an inspection of the vehicle is not posted, then the consumer may request the inspection 1 to analyze whether or not the consumer would like to purchase the car. The request is entered into the software components of the electronic system.

The software may then notify the vehicle owner 2 by sending a notification text, e-mail, phone call, or the like. A list of inspection locations may be stored on the database. In certain embodiments, the software may present the listing of inspection locations that may inspect the car and may provide the vehicle owner with those locations 3. In certain embodiments, the software may further display times at which the vehicle owner may bring the car in. Therefore, the vehicle owner may look through the list of inspection locations and determine which location and what time is most convenient for the owner.

In certain embodiments, the inspection location may include software that is linked up to the database. Once the vehicle owner has determined the time and the location to which they would like to bring their vehicle, the owner may bring the car to location to get inspected 4. The inspection may be taken at the inspection facility 5. In certain embodiments, the inspection may be based on standardized criteria. Since the inspection locations may be electronically linked with the database by software program, the results to the inspection may be captured and uploaded to the database.

Once the inspection results have been uploaded to the database, the consumer may be notified. The consumer may view the results and determine whether the consumer would like to purchase the vehicle. If the consumer does not purchase the vehicle, the results may be posted on the website in which the car is being sold for future consumers to view.

Completing the step of the present invention may enable a highly-coordinated and efficient method of determining and reporting a used vehicle's current operation condition. The present invention may further include multiple alternative embodiments. For example, the owner may initiate their inspection request and therefore would not need to be notified of the request. Further, in alternative embodiments, the owner may first find an inspection location convenient to them prior to the request. In further alternate embodiments, the owner may bring the vehicle to the specific location without the first initiating request. In such embodiments, the request by the consumer may come after the owner has brought the car to the inspection location.

By following the steps above, a consumer may request and obtain reliable, standardized assessments of a vehicle's current operating condition. The present invention may further be used to initiate inspections or assessments of any product or service. For example, the present invention may be used for collectibles, where the prospective buyer would like a knowledgeable third-party inspection that can be initiated in an efficient, electronic method. Further, this may be used for sellers that would like to preemptively obtain an intermediary inspection to increase buyer confidence.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for a consumer to acquire an expert analysis of a product or service of a seller comprising:
a computer having a user interface; and
a program product comprising a machine-readable program code for causing, when executed, the computer to perform the following process steps:
producing information to a consumer, wherein the information comprises a product or service to be sold by a seller;
prompting a user to request an expert analysis about the product or service;
receiving an input of the request for the expert analysis;
notifying the seller of the request;
prompting the seller to schedule an appointment with an expert for the expert analysis;
receiving an input of the expert analysis; and
producing the expert analysis to the consumer.

2. The system of claim 1, wherein the product is a vehicle and the expert analysis is a vehicle inspection.

3. The system of claim 1, further comprising the step of producing a plurality of experts and expert locations for the seller to choose from.

4. The system of claim 3, further comprising the step of producing a plurality of appointment times with the plurality of expert locations.

5. The system of claim 4, further comprising the step of receiving an inputted choice of the expert from the seller.

6. The system of claim 4, wherein the information comprising the product or service to be sold by a seller, the plurality of expert locations and the expert analysis is saved on a database.

7. The system of claim 1, wherein the computer comprises at least one of a desktop, laptop, smart phone, and tablet.

8. The system of claim 1, wherein the computer is multiple computers communicating using the internet.
